(19) United States
(12) Patent Application Publication
(10) Pub. No.: US 2021/0064598 A1
(43) Pub. Date: Mar. 4, 2021

(54) MANAGEMENT SERVER AND MANAGEMENT METHOD

(71) Applicant: FUJITSU LIMITED, Kawasaki-shi (JP)

(72) Inventor: Koichi Onoue, Kawasaki (JP)

(73) Assignee: FUJITSU LIMITED, Kawasaki-shi (JP)

(21) Appl. No.: 16/942,427

(22) Filed: Jul. 29, 2020

(30) Foreign Application Priority Data
Sep. 2, 2019 (JP) 2019-159658

(51) Int. Cl. G06F 16/23; G06F 16/16

(52) U.S. Cl. CPC G06F 16/2365; G06F 16/162

(57) ABSTRACT

A management method executed by a computer, the management method includes receiving a service registration request from a terminal device, the service registration request including an expiration date of data associated with a service program for providing a service; generating management data including a management process for managing data to be used in the service based on the service registration request; and storing the service program and the management data in a storage device in association with each other, wherein the management process includes: activating processing for providing the data used in the service program corresponding to the service when the service is executed; and activating processing for deleting the data when an expiration date of the data has passed.

### CROSS-REFERENCE TO RELATED APPLICATION

This application is based upon and claims the benefit of priority of the prior Japanese Patent Application No. 2019-159658, filed on Sep. 2, 2019, the entire contents of which are incorporated herein by reference.

### FIELD

The embodiments discussed herein are related to a management server and a management method.

### BACKGROUND

In recent years, it has become difficult to create a new business only by utilizing data held by our company. Therefore, attempts have been made to use the data and services of other companies to create value in new business areas. For example, services such as a service for predicting a taxi boarding demand using data held by a taxi company and data held by the Meteorological Agency have been created.

In such a co-creation service in which data provided by a provider is used by a data user to provide a service, the life cycle of the data is managed. The life cycle of data means, for example, an effective period of data provided by a provider to a user, and may include generation of data, update of data, and deletion of data.

For example, related art is disclosed in Japanese Laid-open Patent Publication No. 2017-142641, Japanese Laid-open Patent Publication No. 2017-220862, and Japanese National Publication of International Patent Application No. 2016-500164.

### SUMMARY

According to an aspect of the embodiments, a management method executed by a computer, the management method includes receiving a service registration request from a terminal device, the service registration request including an expiration date of data associated with a service program for providing a service; generating management data including a management process for managing data to be used in the service based on the service registration request; and storing the service program and the management data in a storage device in association with each other, wherein the management process includes: activating processing for providing the data used in the service program corresponding to the service when the service is executed; and activating processing for deleting the data when an expiration date of the data has passed.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating an exemplary life cycle of data;

FIG. 2 is a diagram exemplifying a configuration of a management platform system that manages a life cycle of data according to an embodiment;

FIG. 3 is a diagram exemplifying a block configuration of a management server according to an embodiment;

FIG. 4 is a diagram exemplifying a block configuration of a server according to an embodiment;

FIG. 5 is a diagram exemplifying a data registration request according to an embodiment;

FIG. 6 is a diagram exemplifying an operation flow of data registration processing according to an embodiment;

FIG. 7 is a diagram exemplifying data management information according to an embodiment;

FIG. 8 is a diagram exemplifying a service registration request according to an embodiment;

FIG. 9 is a diagram exemplifying an operation flow of service registration processing according to an embodiment;

FIG. 10 is a diagram exemplifying service management information according to an embodiment;

FIG. 11 is a diagram exemplifying autonomous management data according to an embodiment;

FIG. 12 is a diagram illustrating an operation flow of service activation processing according to an embodiment;

FIG. 13 is a diagram exemplifying an operation flow of data management processing according to an embodiment;

FIG. 14 is a diagram illustrating an operation flow of updated data provision processing according to an embodiment;

FIG. 15 is a diagram exemplifying an operation flow of generated data management processing according to a variation;

FIG. 16 is a diagram exemplifying autonomous management data according to a variation;

FIG. 17 is a diagram illustrating another example of providing data to the server; and

FIG. 18 is a diagram exemplifying a hardware configuration of a computer for realizing the management server and the server according to an embodiment.

### DESCRIPTION OF EMBODIMENTS

However, there are situations in which it is difficult for a data provider or a data user to appropriately manage the life cycle of data.

In view of the above, it is desirable to provide a technique capable of appropriately managing the life cycle of data.

Hereinafter, some embodiments of the present disclosure will be described in detail with reference to the drawings. The corresponding components in a plurality of the drawings are denoted by the same reference signs,

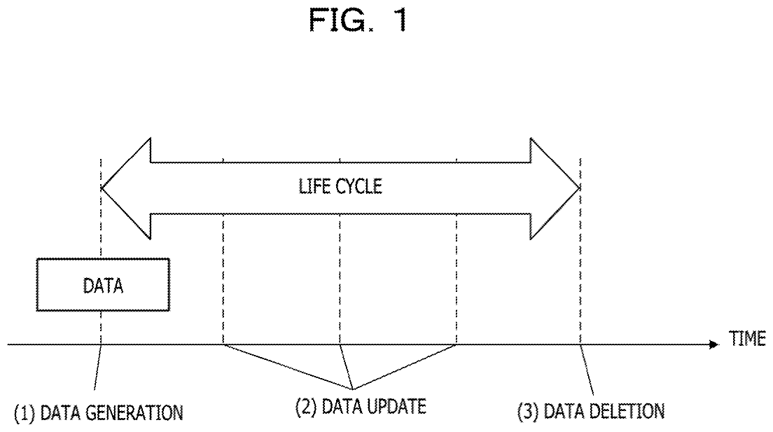

FIG. 1 is a diagram illustrating an exemplary life cycle of data. For example, when a user is provided with data from a provider, the user makes a contract or the like with the provider for the use of the data in accordance with the purpose, receives the data from the provider, and generates data suitable for the purpose of the user ((1) in FIG. 1). Depending on the purpose of use of the data by the user, freshness of the data may be important, and it is desirable that the provided data is updated at an appropriate timing such as when the data is updated ((2) in FIG. 1).

For example, in a department store or the like, in a case where it is desired to quickly capture a change in characteristics of a customer or the like, there is a case where it is desired to continuously perform customer analysis with data of use of a newly acquired credit card or the like. As another example, there is a case where it is desired to perform a regional analysis by continuously following a change in a shop name or an address. For example, in such a case, it is desired that a user receives data update at an appropriate timing even after receiving data from a provider.

It is also desired to delete the data provided to the user at an appropriate timing such as when a date, until which the use of the data is permitted, determined between the provider and the user (hereinafter, such date may be referred to as an expiration date) expires ((3) in FIG. 1).

For example, when personal information and information similar thereto are provided, the provided pieces of data have to be reliably deleted after use from the viewpoint of data protection. As an example, when a user receives provision of information on a credit card from a provider, the data has to be reliably deleted based on a contract with a customer since the data includes personal information, which is confidential data. However, on the other hand, when the user completes the use of data, the user may forget to delete the data that is no longer used. Therefore, it is desired to provide a technique capable of appropriately managing the life cycle of data.

As one example of managing the life cycle of data, it is considered that a data user executes management of the life cycle of data such as update and deletion of data. However, in this case, a cost for the life cycle management is incurred for the data user. Since a provider may not operate the data held by the user, the provider may not cope with the occurrence of an event such as the user forgetting to delete the data. This may result in data leakage.

As another example, it is considered that a data provider executes management of the life cycle of data. For example, the data provider may manage the life cycle by preparing a data store and controlling access to data used by a user. However, in this case, the user uses the data by accessing the data via a network, so the performance of a service provided by the user is degraded. When a plurality of services use the same data, access is concentrated, which degrades the performance of the services. The service provided by the user may store data acquired from the data store in a local storage area, which may also lead to data leakage.

As described above, it may be difficult for a data provider and a data user to reliably manage the life cycle of data.

In the embodiment described below, a management platform for managing the life cycle of data is provided. In the management platform, when data is provided to a service of a user, the data is provided to the service, autonomous management data having a function of autonomously managing the life cycle of the data is generated, and the autonomous management data is provided to the service. For example, when the autonomous management data is executed in a server in which the service is operated, the autonomous management data activates a management process of presenting the data in a format usable by the service and deleting the data when an expiration date set for the data has passed. Therefore, the life cycle of the data may be appropriately managed by the management process activated for the use of the data. By using such a management platform, it is possible to separate the management of the life cycle of data from a data user and a data provider. Hereinafter, the embodiment will be described in more detail.

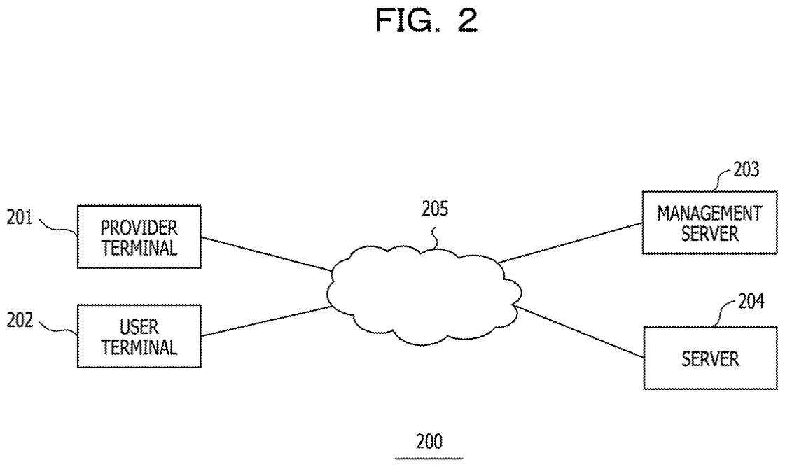

FIG. 2 is a diagram exemplifying a configuration of a management platform system 200 that manages a life cycle of data according to the embodiment. The management platform system 200 includes, for example, a provider terminal 201, a user terminal 202, a management server 203, and a server 204. The provider terminal 201, the user terminal 202, the management server 203, and the server 204 may be coupled via, for example, a network 205.

The provider terminal 201 is, for example, a terminal of a provider who provides data. The provider terminal 201 may transmit data to be provided to a user to the management server 203. The user terminal 202 is, for example, a terminal of a user who provides a service using data of a provider. The user terminal 202 transmits, for example, service information including a service program for providing a service and identification information for identifying data of a provider used in the service to the management server 203.

The management server 203 is, for example, a server that manages the management platform system 200. For example, when receiving data from the provider terminal 201, the management server 203 may store the data. For example, when receiving service information from the user terminal 202, the management server 203 generates autonomous management data having a function of autonomously managing the life cycle of data identified by identification information. The management server 203 pairs a service program that provides a service and the autonomous management data having a function of autonomously managing the life cycle of data used by the service program, and arranges the service program and the autonomous management data in the server 204.

Such autonomous management data having a function of autonomously managing the life cycle of data may be realized by using, for example, a computer virtualization technique called container. The container is a system of virtualization of a computer. The container is a system in which a dedicated area isolated from others is created over an operating system (OS) in operation to virtually create a new OS execution environment, and software is operated over the new OS execution environment. This isolated area is called a container. In the following embodiment, a case in which a container is used as autonomous management data will be exemplified.

The server 204 is, for example, a server for providing a service of a user. For example, when autonomous management data is executed in the server 204, a management process is activated. The management process provides data used in a service in a format usable by a service program. The service activated by executing the service program is provided by referring to the presented data. For example, the management process may delete the data and stop the use of the data in the service upon passage of the expiration date of the data.

Although one server 204 is illustrated in FIG. 2, the number of servers 204 included in the management platform system 200 according to the embodiment is not limited to one, and a plurality of servers 204 may be included.

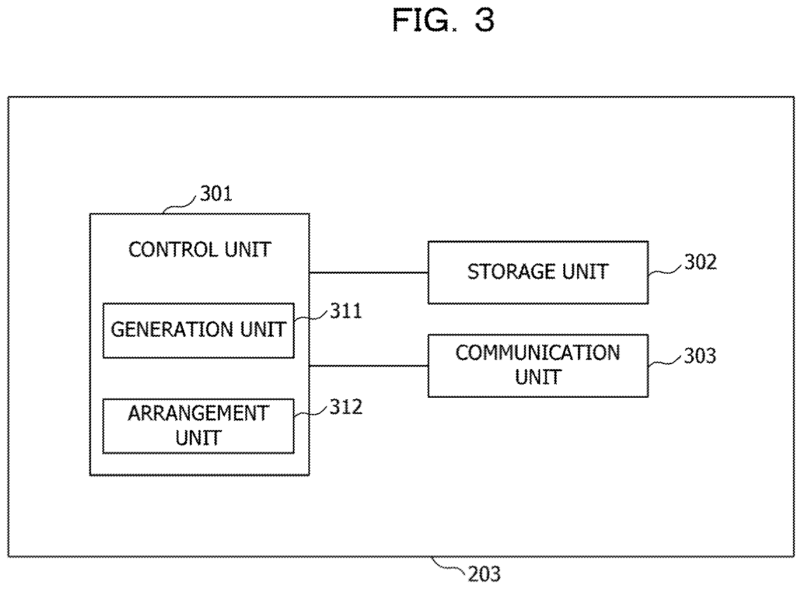

FIG. 3 is a diagram exemplifying a block configuration of the management server 203 according to the embodiment. The management server 203 includes, for example, a control unit 301, a storage unit 302, and a communication unit 303. The control unit 301 includes, for example, a generation unit 311, an arrangement unit 312, and the like. For example, the storage unit 302 may store information such as data 502, data management information 700, a service program 802, and service management information 1000, each of which will be described later. For example, the communication unit 303 communicates with the provider terminal 201, the user terminal 202, and the server 204 via the network 205 in accordance with an instruction from the control unit 301. Each of these units and information stored in the storage unit 302 will be described later in detail.

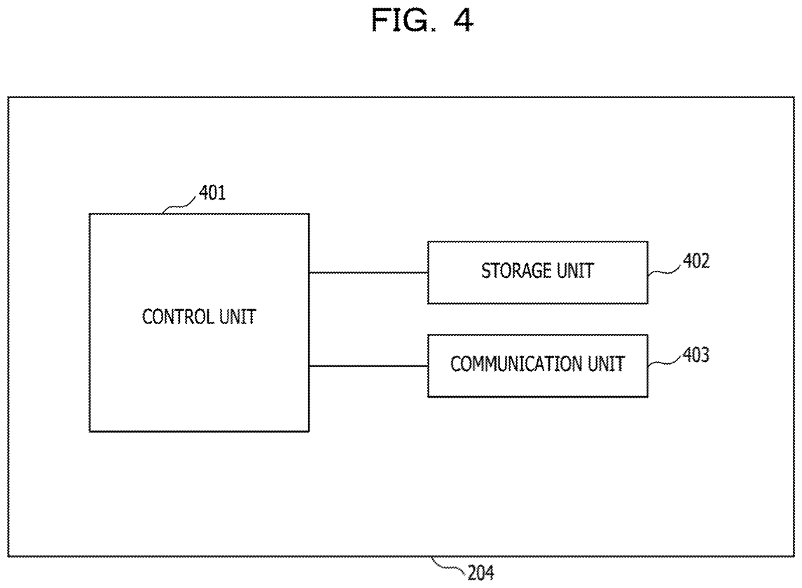

FIG. 4 is a diagram exemplifying a block configuration of the server 204 according to the embodiment. The server 204 includes, for example, a control unit 401, a storage unit 402, and a communication unit 403. For example, the control unit 401 executes the service program 802 described later to provide a service, and manages the data 502 by a management process generated by executing autonomous management data 1100. For example, the storage unit 402 may store information such as the service program 802, the autonomous management data 1100, and autonomous management data 1600, each of which will be described later. For example, the communication unit 403 communicates with the management server 203 via the network 205 in accordance with an instruction from the control unit 401. Each of these units and information stored in the storage unit 402 will be described later in detail.

Next, registration processing of data of a provider by the management server 203 according to the embodiment will be described.

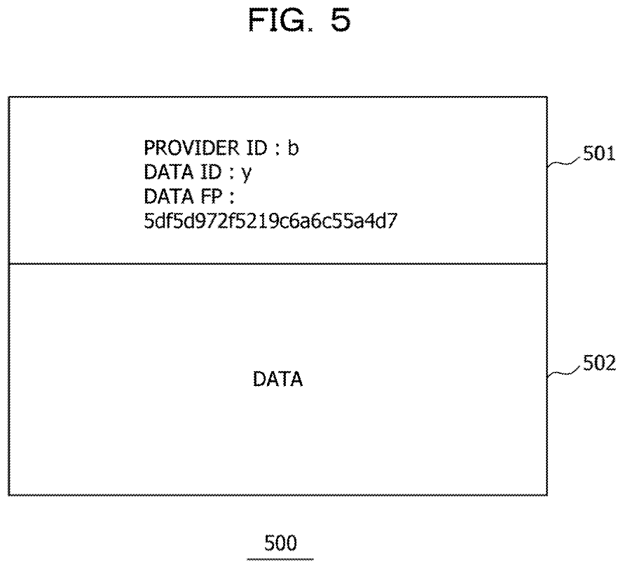

FIG. 5 is a diagram exemplifying a data registration request 500 according to the embodiment for the provider terminal 201 to request the management server 203 to register data. The data registration request 500 includes, for example, data information 501 and the data 502. The data information 501 is, for example, information on data to be registered, and the data 502 is data to be provided to a user. In the example of FIG. 5, the data information 501 includes information of a provider identifier (ID) for identifying a data provider, a data ID for identifying the data 502, and a data fingerprint (FP) generated based on the data 502. The data FP may be, for example, a value generated from the data 502 using a hash function or the like. The data FP may be used, for example, to detect corruption or tampering of the data 502.

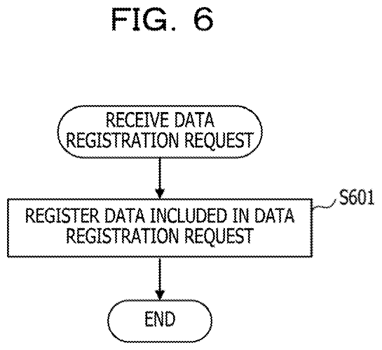

FIG. 6 is a diagram exemplifying an operation flow of data registration processing executed by the management server 203 according to the embodiment. For example, when receiving the data registration request 500 from the provider terminal 201 used by a provider, the control unit 301 of the management server 203 may start the operation flow in FIG. 6.

In step 601 (hereinafter, step is described as “S”, and this case is described as S601, for example), the control unit 301 of the management server 203 registers the data 502 requested to be registered by the data registration request 500 in the management platform system 200. For example, the control unit 301 may store the data 502 included in the data registration request 500 in a predetermined folder or the like of the storage unit 302. The control unit 301 may register the data information 501 of the data registration request 500 in the data management information 700.

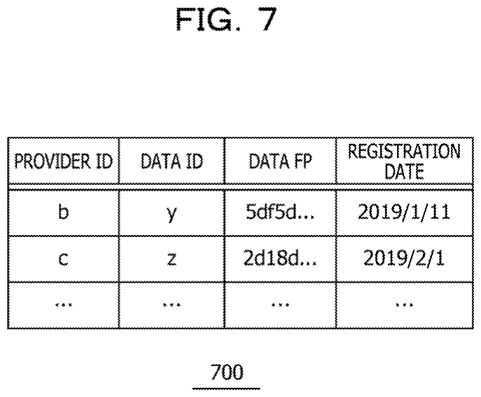

FIG. 7 is a diagram exemplifying the data management information 700 according to the embodiment. In the data management information 700, for example, records in each of which a provider ID of data, a data ID, a fingerprint of data, and a registration date are associated with each other, are registered. For example, as a provider ID, a data ID, and a fingerprint of data, the provider ID, the data ID, and the data fingerprint of the data information 501 may be registered, respectively. The control unit 301 may register, as a registration date of a record, the date when the registration of the record in the data management information 700 is executed. In the data management information 700, records related to data provided from the provider terminals 201 of various providers may be registered. When data registration is completed in S501, the operation flow in FIG. 6 ends.

According to the operation flow in FIG. 6 described above, the control unit 301 may store the data 502 provided from a provider and register information on the data 502 in the data management information 700.

When at least a part of the data 502 registered in the data management information 700 is updated, the provider terminal 201 may notify the management server 203 of the data registration request 500 including the updated data again. In this case, the control unit 301 of the management server 203 may update, in S601, data identified by the same data ID in a predetermined folder of the storage unit 302, with the updated data notified in the data registration request 500. The control unit 301 of the management server 203 may update the data FP of the record whose data ID matches that of the data registration request 500 to the data FP of the data registration request 500 notifying of the updated data, and rewrite the registration date with the updated date.

Next, registration of a service of a user in the management platform system 200 by the management server 203 according to the embodiment will be described.

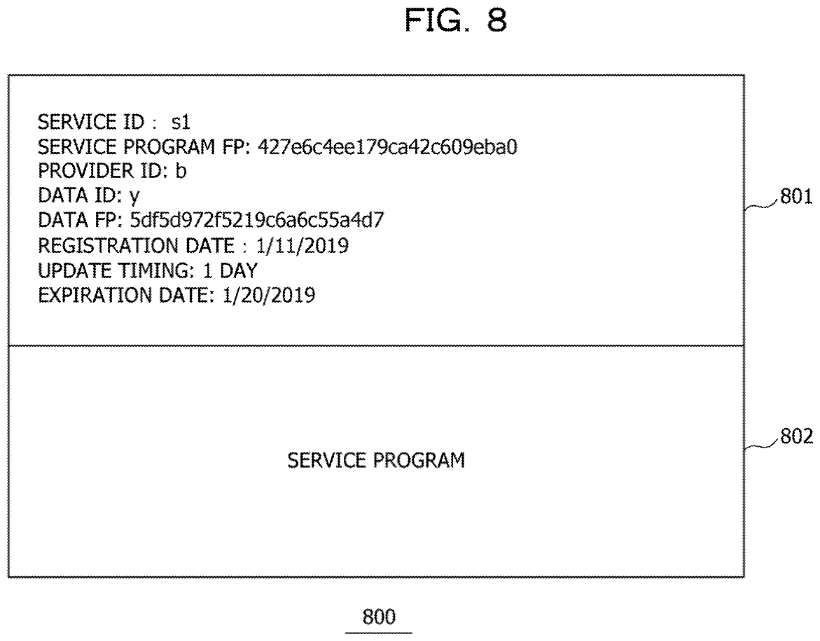

FIG. 8 is a diagram exemplifying a service registration request 800 according to the embodiment for the user terminal 202 to request the management server 203 to register a service. The service registration request 800 includes, for example, service information 801 and the service program 802. The service information 801 is, for example, information on a service to be registered in the management platform system 200, and the service program 802 is a program for providing the service. In the example of FIG. 8, the service information 801 includes information of a service ID, a service program FP, a provider ID, a data ID, a data FP, a registration date, an update timing, and an expiration date.

The service ID is, for example, identification information for identifying a service provided by a user. The service program FP is, for example, a fingerprint of a program that provides a service. The service program FP may be used, for example, to detect damage or tampering of a program. The provider ID is, for example, identification information indicating a data provider used in the service indicated oy the service registration request 800. The data ID is, for example, identification information for identifying data used in the service identified by the service ID of the service registration request 800, and the data FP is a fingerprint of the data. The registration date is a date when data identified by the data ID of the service registration request 800 is registered in the management platform system 200. The update timing is, for example, information indicating a timing for confirming update of the data identified by the data ID of the service registration request 800. The expiration date is, for example, an expiration date of the data identified by the data ID of the service registration request 800. For example, a user may make an agreement in advance about a method of using data or the like at a timing such as when the user applies for the use of the data to a data provider, and create the service registration request 800 based on information collected from the provider under the agreement.

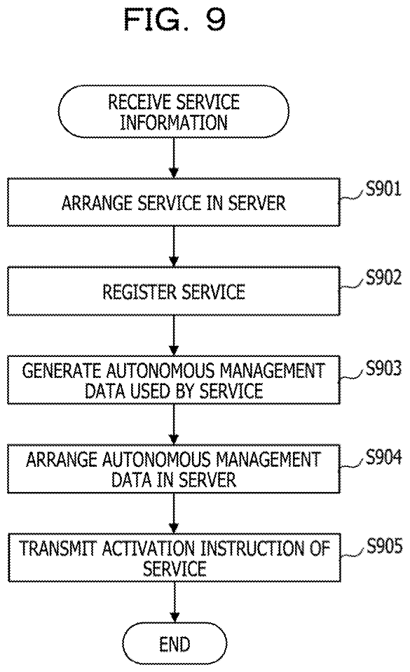

FIG. 9 is a diagram exemplifying an operation flow of service registration processing according to the embodiment. For example, the control unit 301 of the management server 203 may start the operation flow in FIG. 9 when information indicating the expiration date of the data 502 associated with the service program 802 is input, such as when the service registration request 800 is received from the user terminal 202.

In S901, the control unit 301 arranges, in the server 204, the service program 802 notified in the service registration request 800. For example, the control unit 301 may arrange the service program 802 of the service registration request 800 in the server 204 having a sufficient processing capacity or a sufficient space for arranging the service in the storage area among the servers 204 included in the management platform system 200.

In S902, the control unit 301 registers, for example, a record related to a service notified in the service registration request 800 in the service management information 1000.

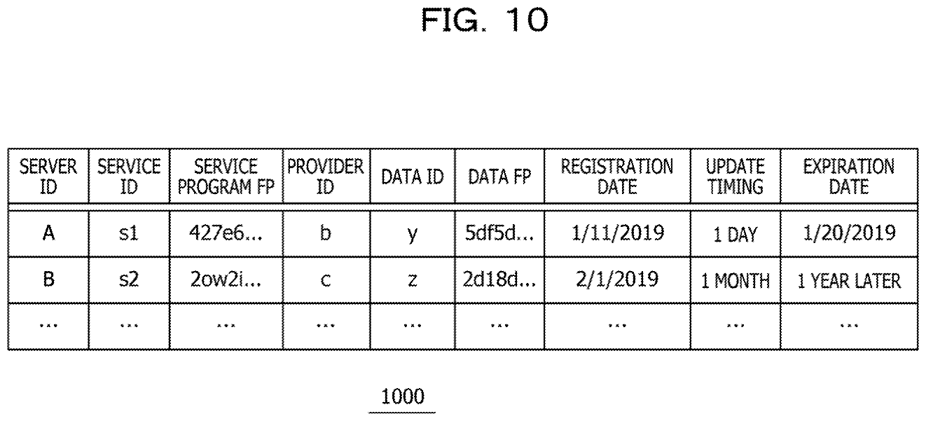

FIG. 10 is a diagram exemplifying the service management information 1000 according to the embodiment. In the service management information 1000, for example, a record in which a server ID, a service ID, a service program FP, a provider ID, a data ID, a data FP, a registration date, an update timing, and an expiration date are associated with each other, is registered. The server ID is, for example, identification information for identifying the server 204 in which the service of the record is arranged. The service ID, the service program FP, the provider ID, the data ID, the data FP, the registration date, the update timing, and the expiration date of the service management information 1000 are information acquired from the service ID, the service program FP, the provider ID, the data ID, the data FP, the registration date, the update timing, and the expiration date of the service registration request 800, respectively. In S902, the control unit 301 may register, in the service management information 1000, a record in which the identification information of the server 204 in which the service program 802 is arranged in S901 is associated with the information of the service information 801 of the service registration request 800.

In S903, the control unit 301 generates autonomous management data for autonomously managing the data 502 used in a service notified in the service registration request 800. The autonomous management data is, for example, data including a management program for managing data used in a service. In one example, the data 502 as a management target may be included. As a method of generating such autonomous management data including a management program for managing data used in a service, a computer virtualization technique called a container may be used as described above.

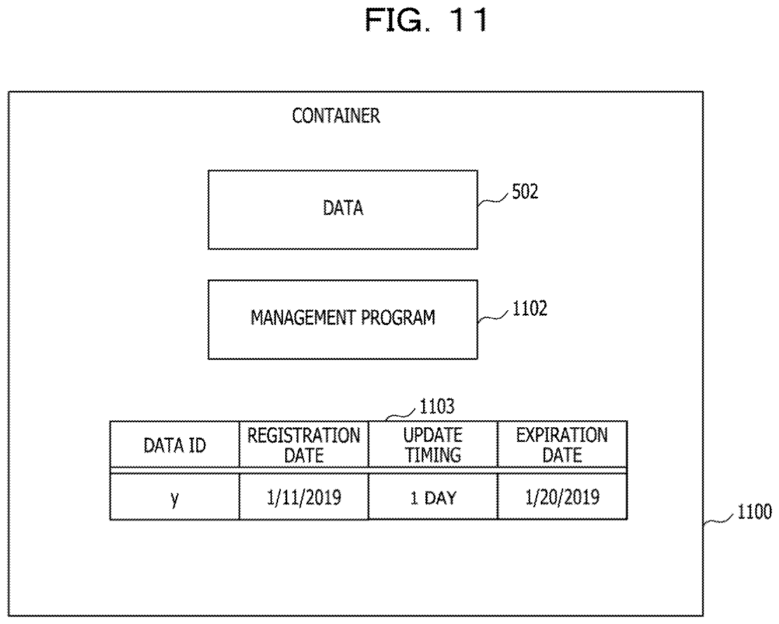

FIG. 11 is a diagram exemplifying the autonomous management data 1100 according to the embodiment generated in S903. In the example of FIG. 11, a container is illustrated as the autonomous management data 1100, and the container includes the data 502 used in a service, a management program 1102 for managing the data 502, and management information 1103 including information on management of the data 502. The management information 1103 may include, for example, a data ID for identifying the data 502, and information on a registration date, an update timing, and an expiration date of the data. These pieces of information may be acquired from the service registration request 800 when the container is generated, for example.

In S904, the control unit 301 arranges the autonomous management data 1100 generated in S903 in the server 204 in which the service program 802 is arranged in S901.

In S905, the control unit 301 transmits an activation instruction of a service provided by the service program 802 to the server 204 in which the service is arranged, and the operation flow ends.

According to the operation flow in FIG. 9 described above, the service program 802 and the autonomous management data 1100 having a function of managing the data 502 used in the service provided by the service program 802 may be arranged in the server 204.

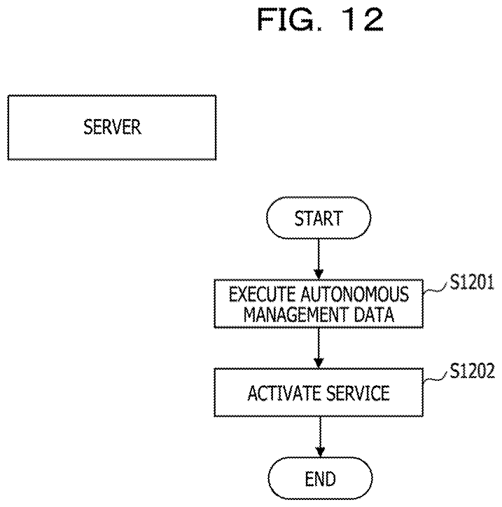

Next, activation of a service in the server 204 will be described. FIG. 12 is a diagram illustrating an operation flow of service activation processing executed by the control unit 401 of the server 204 according to the embodiment. For example, when receiving a service activation instruction from the management server 203, the control unit 401 of the server 204 may start the operation flow in FIG. 12.

In S1201, the control unit 401 executes a container provided as the autonomous management data 1100. In one example, when the control unit 401 executes a container provided as the autonomous management data 1100, a management process for managing the data 502 may be activated, and the activated management process may execute the management program 1102 to manage the data 502.

For example, when the management process is activated, the management process may provide the data 502 in a format usable by the control unit 401 executing the service program 802. For example, at the time of activation, the management process may mount a predetermined area such as a folder in which the data 502 in the container is stored so as to be shared with a predetermined area such as another folder outside the container in the storage unit 402 of the server 204. Accordingly, the control unit 401 executing the service program 802 may access the data 502.

Subsequently, in 51202, the control unit 401 executes the service program 802 to activate the service, and the operation flow ends. The control unit 401 executing the service program 802 provides the service by referring to the data 502 provided in a usable format by the management process.

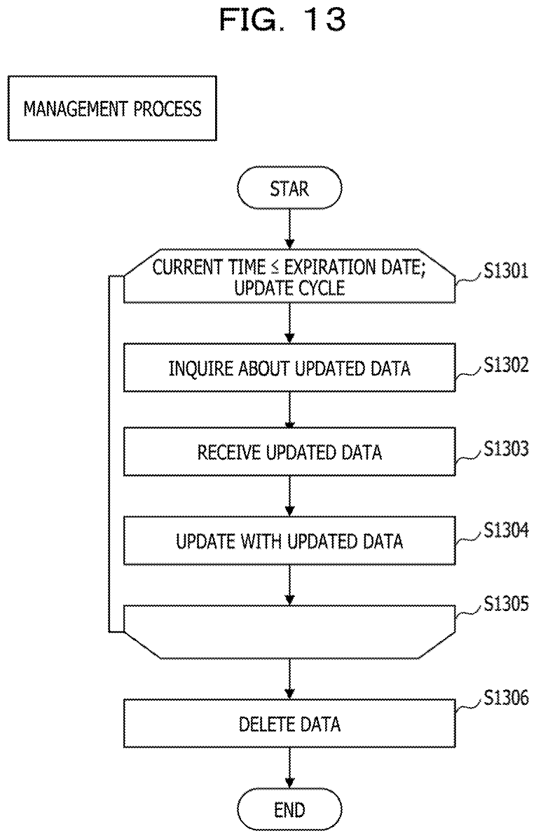

Next, management processing of the data 502 by a management process activated by the control unit 401 of the server 204 executing the autonomous management data 1100 according to the embodiment will be described. FIG. 13 is a diagram exemplifying an operation flow of management processing of the data 502 by the control unit 401 operating as a management process according to the embodiment. For example, when the management process is activated in the server 204, the management process may start the operation flow in FIG. 13.

The processing in S1301 to S1305 is repeated. For example, if the current time has not passed an expiration date, the management process executes update processing for attempting to update the data 502 in S1302 to S1304 at an update timing described in the management information 1103.

In S1302, for example, the management process inquires of the management server 203 whether there is updated data obtained by updating the data 502. The inquiry may include, for example, information on the data ID and the registration date of the management information 1103. If there is updated data in the management server 203, the management process receives the updated data in S1303. If there is no updated data in the management server 203, the management process may receive a response indicating that there is no updated data in S1303.

In S1304, if the management process has received the updated data, the management process updates the data 502 and the registration date of the management information 1103 in the container with the received updated data and the registration date of the updated data, respectively.

In S1305, if the current time has not passed the expiration date, the management process returns the operation flow to S1301. In this case, after the next update timing arrives in S1301, the processing in S1302 and subsequent processing are repeated. On the other hand, if the management process determines in S1305 that the current time has passed the expiration date, the operation flow advances to S1306.

In S1306, the management process deletes the data 502, for example, and the operation flow ends.

According to the operation flow in FIG. 13 described above, the management process activated by executing the container provided as the autonomous management data 1100 may manage the life cycle such as update and deletion of the data 502. The management process is a process activated when executing the autonomous management data 1100 in order for a service to use the data 502 in the server 204. Therefore, only by arranging the autonomous management data 1100 in the server 204, the life cycle of the data 502 may be autonomously managed in the server 204 without receiving control from the provider terminal 201, the user terminal 202, and the management server 203.

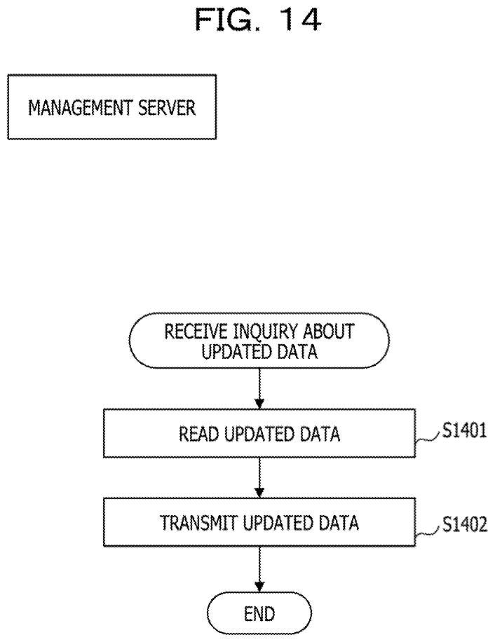

FIG. 14 is a diagram illustrating an operation flow of updated data provision processing executed by the management server 203 according to the embodiment. For example, the control unit 301 of the management server 203 may start the operation flow in FIG. 14 when receiving an inquiry about updated data from the server 204 in the operation flow in FIG. 13.

In S1401, the control unit 301 of the management server 203 refers to the data management information 700, and determines whether there is updated data in the data 502 of inquiry. For example, the control unit 301 may refer to the information of the data ID and the registration date included in the inquiry, and determine that there is updated data when the registration date of the record of the data management information 700 identified by the data ID is later than the registration date included in the inquiry. In this case, the control unit 301 reads the updated data.

In S1402, the control unit 301 notifies the server 204 that has made the inquiry of the read updated data and the registration date of the updated data, and the operation flow ends. If there is no updated data in S1401, the control unit 301 may notify the server 204 that has made the inquiry of a response indicating that there is no updated data in S1402.

As described above, according to the embodiment, a service provided by the server 204 may be provided with the data 502 by using the autonomous management data 1100 having a function of autonomously managing the life cycle of the data 502. According to the autonomous management data 1100, when the autonomous management data 1100 is executed in order to use the data 502, a management process is activated, and the management process may delete the data 502 of which the expiration date has passed. According to the autonomous management data 1100, the data 502 may be updated at a predetermined update timing by the management process that is activated when the autonomous management data 1100 is executed. Therefore, according to the embodiment, the life cycle of the data 502 may be appropriately managed.

In the above-described embodiment, since the autonomous management data 1100 is arranged in the server 204 in which the service operates, the control unit 401 of the server 204 may access the data 502 of the autonomous management data 1100 that is locally present and execute the processing. Therefore, compared to a case where the data 502 is arranged in a different server such as the management server 203 and the data is provided via a network, the performance of the service may be improved. Since the autonomous management data 1100 may be individually arranged in the server 204 for each service, the performance of the service may be improved compared to a case where the service is provided by a plurality of services referring to one piece of data 502. For example, compared to a case where the life cycle of the data 502 is collectively managed by the management server 203, according to the embodiment, the management processing is distributed and parallelized in each server 204 using the autonomous management data 1100. Therefore, it is possible to level the load generated by the management processing of the life cycle of the data 502,

(Variation)

Next, a variation of the above-described embodiment will be described. For example, at least a part of the data 502 provided in the autonomous management data 1100 may be duplicated to generate additional data. For example, a user may combine pieces of the data 502 included in a plurality of different pieces of the autonomous management data 1100 to generate new data and use the new data in a service. In this case, it is desirable to similarly execute life cycle management for the data 502 obtained by duplicating at least a part of the data.

Therefore, in the variation, for example, an example in which, when at least a part of the data 502 provided by the autonomous management data 1100 is duplicated to generate new data, the autonomous management data 1100 for managing the life cycle of the new data is provided, will be described.

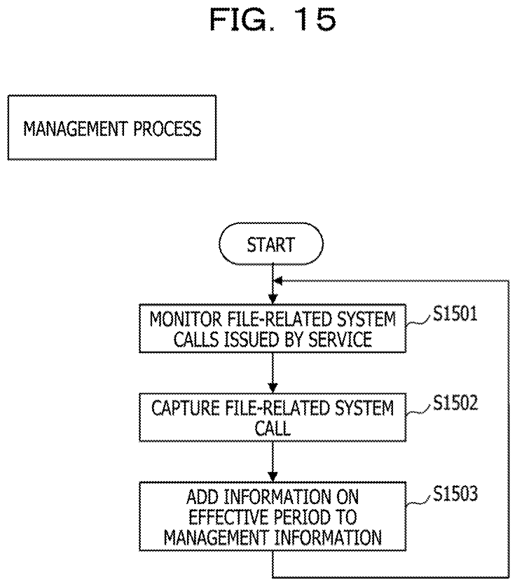

FIG. 15 is a diagram exemplifying an operation flow of generated data management processing by a management process activated by the control unit 401 of the server 204 executing the autonomous management data 1100 according to the variation. For example, the management process may start the operation flow in FIG. 15 upon activation.

In S1501, the management process monitors issuance of a file-related system call by a service. File-related system calls may be, for example, open( ), creat( ), rename( ), or the like. When the management process detects a file-related system call issued by the service, the operation flow proceeds to S1502. New data generated by duplicating at least a part of the data 502 may be arranged in a container.

In S1502, the management process captures a file-related system call. For example, the management process may collect information on name and path of data generated as a result of the system call.

In S1503, the management process assigns a data ID for identification to the generated data, and registers a record in which the data ID is associated with information of the update timing and the expiration date in the management information 1103.

For example, in a case where one piece of data 502 is used to generate new data, the update timing and the expiration date of the data 502 that is the generation source may be set as the update timing and the expiration date. For example, in a case where there are a plurality of pieces of data 502 used to generate new data, representative values respectively representing update timings and expiration dates of the plurality of pieces of data 502 may be set as the update timing and the expiration date. For example, a representative value representing a plurality of update timings may be the shortest update timing or the longest update timing among update timings set in the plurality of pieces of data 502. Similarly, for example, a representative value representing a plurality of expiration dates may be the earliest expiration date or the latest expiration date among expiration dates set in the plurality of pieces of data 502. The update timing set for new data may be referred to as a second update timing. The expiration date set for new data may be referred to as a second expiration date.

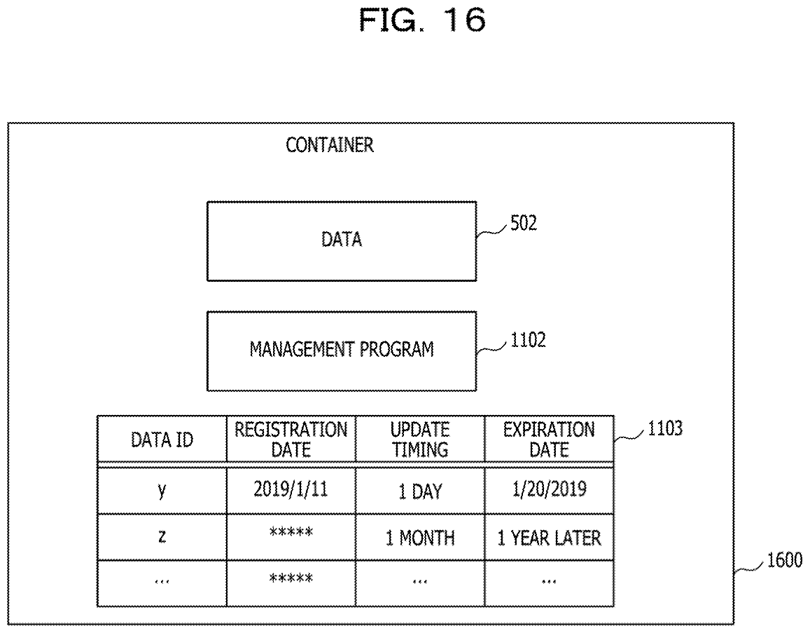

FIG. 16 is a diagram exemplifying the autonomous management data 1600 including the update timing and the expiration date of new data according to the variation. Compared to the autonomous management data 1100 in FIG. 11, in the autonomous management data 1600 illustrated in FIG. 16, a record for new data is added to the management information 1103.

For example, the management process executes the operation flow in FIG. 13 for each piece of data of each record of the management information 1103 of the autonomous management data 1600, so that the life cycle of new data generated based on the data 502 may also be appropriately managed.

(Second Variation)

In the above-described embodiment, a container is illustrated as an example of the autonomous management data 1100, and an example in which the data 502 is included in the container and arranged in the server 204 is described. However, the embodiment is not limited thereto. In the second variation, when a container is arranged in the server 204, the container may not include the data 502.

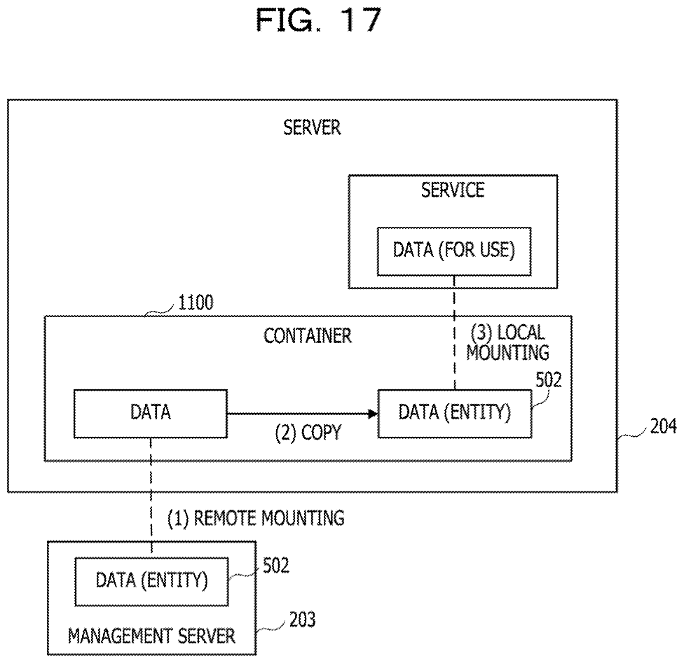

FIG. 17 is a diagram exemplifying provision of the data 502 to the server 204 in a case where a container does not include the data 502 when the container is arranged in the server 204. In the example of FIG. 17, when the control unit 401 executes the container in the server 204 and a management process is activated, the management process performs remote mounting, in the server 204, of the entity of the data 502 in the management server 203 ((1) in FIG. 17). The management process copies the entity of the data 502 from the remotely mounted data 502 into the container ((2) in FIG. 17). The management process further performs local mounting so as to share a predetermined area including the entity of the data 502 copied into the container and a predetermined area such as another folder outside the container of the server 204. This allows a service to use the data 502. In this case, the management process does not have to inquire the management server 203 about the updated data when updating the data 502. Instead, the management process may execute, for example, a process of synchronizing the entity of the data 502 copied into the container so as to match the content of the remotely mounted data 502 at the update timing.

In the above-described embodiment, for example, provision of data may be executed between different servers such as the management server 203 and the server 204 by using a distributed data sharing function such as a network file system (IFS).

As exemplified above, by generating the autonomous management data 1100 having an autonomous management function, it is possible to manage the life cycle of the data 502 while providing the data 502 to the service by using the autonomous management function of the autonomous management data 1100.

Although the embodiment has been exemplified above, the embodiment is not limited thereto. For example, the operation flows described above are exemplary, and the embodiment is not limited thereto. Where possible, the order of performing the types of processing in the operation flows may be changed, the operation flows may further include a different type of processing, or some of the types of the processing in the operation flows may be omitted. For example, the processing of S902 and the processing of S903 in FIG. 9 may be executed by changing the order.

In the above-described embodiment, an example in which the service program 802 is directly arranged in the server 204 is described, but the embodiment is not limited thereto. For example, in another embodiment, the service program 802 may be stored in a container separate from the container storing the data 502. For example, management of the management platform system 200 may be facilitated by storing the service program 802 in a container and pairing and moving the container of the service program and the autonomous management data 1100.

In the above-described embodiment, an example in which the life cycle of the data 502 is managed by a management process generated by activating a container is described, the embodiment is not limited thereto. For example, in another embodiment, instead of a management process, an OS process may be used to manage the life cycle of data.

In the above-described embodiment, an update timing and an expiration date may be specified in various formats. For example, an update timing and an expiration date may be specified in relative time from the current time, may be specified in cycles, or may be specified in absolute time (for example, in a crop format).

In the operation flow in FIG. 13 of the above-described embodiment, the management process deletes the data 502 in the container and the processing ends, the embodiment is not limited thereto. For example, in another embodiment, after the management process deletes the data 502, a deletion instruction to delete the container may be transmitted from the management server 203 to the server 204, and the control unit 401 of the server 204 may delete the container in accordance with the deletion instruction.

In the operation flows in FIGS. 13 and 14 of the above-described embodiment, an example in which a management process inquires of the management server 203 about updated data is described, the embodiment is not limited thereto. For example, in another embodiment, the management server 203 may have a function of transmitting (pushing) updated data to the server 204 when the data 502 is updated. In this case, for example, the management process may temporarily store the updated data and apply the update to the data 502 in the container at the update timing.

In the above-described embodiment, for example, in the processing of S901 to the processing of S903, the control unit 301 of the management server 203 operates as the generation unit 311. For example, in the processing of S904 and the processing of S905, the control unit 301 of the management server 203 operates as the arrangement unit 312.

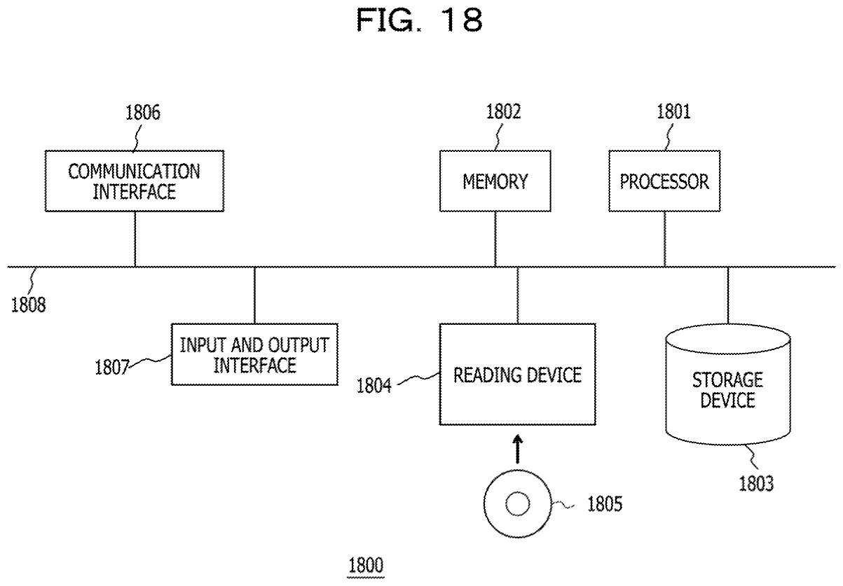

FIG. 18 is a diagram exemplifying a hardware configuration of a computer 1800 for realizing the management server 203 and the server 204 according to the embodiment. The hardware configuration in FIG. 18 includes, for example, a processor 1801, a memory 1802, a storage device 1803, a reading device 1804, a communication interface 1806, and an input and output interface 1807. The processor 1801, the memory 1802, the storage device 1803, the reading device 1804, the communication interface 1806, and the input and output interface 1807 are coupled to each other via a bus 1808, for example.

The processor 1801 may be, for example, a single processor, a multiprocessor, or a multicore processor. The processor 1801 uses the memory 1802 to execute a program in which the procedures for the above-described operation flows are described, thereby providing some or all of the above-described functions of the control unit 301, for example. For example, the control unit 301 of the management server 203 operates as the generation unit 311 and the arrangement unit 312 by reading and executing a program stored in the storage device 1803. For example, the control unit 401 of the server 204 may provide a service by reading and executing the service program 802 stored in the storage device 1803, or may operate as a management process by reading and executing the autonomous management data 1100.

The memory 1802 is, for example, semiconductor memory and may include a RAM area and a ROM area. The storage device 1803 is, for example, a hard-disk drive, semiconductor memory such as flash memory, or an external storage device, RAM is an abbreviation for a random-access memory. ROM is an abbreviation for a read-only memory.

The reading device 1804 accesses a removable storage medium 1805 in accordance with an instruction of the processor 1801. The removable storage medium 1805 is realized by, for example, a semiconductor device (USB memory or the like), a medium (a magnetic disk or the like) to and from which information is input and output by a magnetic action, a medium (CD-ROM, DVD, or the like) to and from which information is input and output by an optical action, or the like. USB is an abbreviation for a Universal Serial Bus. CD is an abbreviation for a compact disc. DVD is an abbreviation for a digital versatile disk.

The storage unit 302 and the storage unit 402 described above may include, for example, the memory 1802, the storage device 1803, and the removable storage medium 1805. The storage unit 302 of the management server 203 may store, for example, the data 502, the data management information 700, the service program 802, the service management information 1000, and the like. The storage unit 402 of the server 204 may store, for example, the service program 802, the autonomous management data 1100, the autonomous management data 1600, and the like.

The communication interface 1806 transmits and receives data via a network, in accordance with an instruction of the processor 1801. The communication interface 1806 is an example of the communication unit 303 and the communication unit 403. The input and output interface 1807 may be, for example, an interface between an input device and an output device. The input device is, for example, a device accepting instructions from a user such as a keyboard or a mouse. The output device is, for example, a display device such as a display and an audio device such as a speaker.

Each program according to the embodiment is provided to the management server 203 and the server 204 in the following form, for example.

(1) Installed in advance, in the storage device 1803.

(2) Provided by the removable storage medium 1805.

(3) Provided from a server such as a program server.

The hardware configuration of the computer 1800 for realizing the management server 203 and the server 204 that is described with reference to FIG. 18 is an example, and the embodiment is not limited thereto. For example, some or all of the above-described functions of the control unit 301 and the control unit 401 may be implemented as hardware such as an FPGA and an SoC. FPGA is an abbreviation for a field-programmable gate array. SoC is an abbreviation for a system-on-a-chip.

Some embodiments have been described above. However, the embodiments are not limited to the above-described embodiments. It is to be appreciated that the embodiments include a number of types of variations and alternatives of the above-described embodiments. For example, it would be appreciated that various types of embodiments are able to be embodied by modifying the elements without departing from the scope of the gist of the embodiments. It would also be appreciated that various types of embodiments are able to be implemented by appropriately combining a plurality of the elements disclosed according to the above-described embodiment. Also, one skilled in the art would appreciate that various types of embodiments are able to be implemented by deleting or replacing a subset of the elements out of all the elements described according to the embodiment or adding an element or elements to the elements described according to the embodiment.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A management server, comprising:
a memory; and
a processor coupled to the memory and configured to:
receive a service registration request from a terminal device, the service registration request including an expiration date of data associated with a service program for providing a service,
generate management data including a management process for managing data to be used in the service based on the service registration request, and
store the service program and the management data in a storage device in association with each other,
wherein the management process includes:
activating processing for providing the data used in the service program corresponding to the service when the service is executed, and
activating processing for deleting the data when an expiration date of the data has passed.

2. The management server according to claim 1, wherein the processor is configured to:
create, over an operating system (OS) in operation, a virtual area which is isolated from others, and
by using the management process being operated in the area, activate processing for providing the data used in the service program corresponding to the service, and activate processing for deleting the data when an expiration date of the data has passed.

3. The management server according to claim 1, wherein the processor is configured to generate the management data so that the management process executes update processing for attempting update of the data at a predetermined update timing.

4. The management server according to claim 1, wherein
when the management process detects a file-related system call from the service, the management process generates the management data so that a second expiration date is set for generated data generated by the system call, and the generated data is deleted after the second expiration date.

5. The management server according to claim 4, wherein
the management process includes generating the management data so as to set, as the second expiration date, a representative value representing a plurality of expiration dates respectively set for a plurality of pieces of data used in the service, the plurality of pieces of data including the data.

6. The management server according to claim 3, wherein
when the management process detects a file-related system call rom the service, the management process includes;
generating the management data so that a second update timing is set for generated data generated by the system call, and
updating processing for attempting update of the generated data is executed in the second update timing.

7. The management server according to claim 6, wherein
the management process includes generating the management data so as to set, as the second update timing, a representative value representing a plurality of update timings respectively set for a plurality of pieces of data used in the service, the plurality of pieces of data including the data.

8. A management method executed by a computer, the management method comprising:
receiving a service registration request from a terminal device, the service registration request including an expiration date of data associated with a service program for providing a service;
generating management data including a management process for managing data to be used in the service based on the service registration request; and
storing the service program and the management data in a storage device in association with each other,
wherein the management process includes:
activating processing for providing the data used in the service program corresponding to the service when the service is executed, and
activating processing for deleting the data when an expiration date of the data has passed.
